(19) United States
(12) Patent Application Publication
(10) Pub. No.: US 2016/0118682 A1
(43) Pub. Date: Apr. 28, 2016

(54) FLAT-WINDING TYPE SECONDARY BATTERY

(71) Applicant: HITACHI AUTOMOTIVE SYSTEMS, LTD., Hitachinaka-shi, Ibaraki (JP)

(72) Inventors: Yoshinori IIZUKA, Hitachinaka (JP); Satoshi WATANABE, Hitachinaka (JP); Toshiyuki ARIGA, Hitachinaka (JP)

(73) Assignee: HITACHI AUTOMOTIVE SYSTEMS, LTD., Hitachinaka-shi, Ibaraki (JP)

(21) Appl. No.: 14/898,484

(22) PCT Filed: Jun. 28, 2013
(86) PCT No.: PCT/JP2013/067768

§ 371 Date: Dec. 15, 2015

(51) Int. Cl. H01M 10/04; H01M 10/0525

(52) U.S. Cl. CPC H01M 10/0431; H01M 10/0525; H01M 2220/20

(57) ABSTRACT

An object of the present invention is to provide a flat-winding type secondary battery having a simple structure and thus capable of being manufactured in a simplified manufacturing process. A flat-winding type secondary battery according to the present invention is a flat-winding type secondary battery having a flat-shaped winding group obtained by winding positive and negative electrodes with separators interposed therebetween. The winding group has a shaft core having a configuration in which leading end portions of a sheet member at both sides in a winding direction are folded in an a mutually approaching direction and disposed at positions separated from each other, the sheet member having a higher bending rigidity than that of any of the positive and negative electrodes and separators.

### TECHNICAL FIELD

The present invention relates to a high-capacity flat-winding type secondary battery for, e.g., a vehicle.

### BACKGROUND ART

In recent years, as a power source for an electric car and the like, a high energy density lithium-ion secondary battery having a structure in which positive and negative electrodes are wound with a separator interposed therebetween is being developed. The lithium-ion secondary battery is expanded in application with improvement in its performance and, accordingly, simplification of a manufacturing process and reduction in cost are required. In such a circumstance, a technology is disclosed in which a stainless-steel or synthetic resin seamless cylinder is used as a shaft core around which the electrode is wound, and the cylindrical shaft core is crushed after the winding of the electrode together with a wound electrode body (PTL 1).

### CITATION LIST

### Patent Literature

PTL 1: JP 2002-280055 A

### SUMMARY OF INVENTION

### Technical Problem

In the conventional technology, the cylindrical shaft core needs to be previously inserted into a spindle of a winder so as to be attached thereto before the winding of the electrode by the winder, which inhibits productivity improvement by automation. Further, production of the synthetic resin seamless cylinder as the cylindrical shaft core is not suitable for mass production in terms of cost.

The present invention has been made in view of the above problems, and an object thereof is to provide a flat-winding type secondary battery having a simple structure and thus capable of being manufactured in a simplified manufacturing process.

### Solution to Problem

A flat-winding type secondary battery of the present invention to solve the above problems includes: a flat-shaped winding group obtained by winding positive and negative electrodes with a separator interposed therebetween, the winding group having a shaft core having a configuration in which leading end portions of a sheet member at both sides in a winding direction are folded in an a mutually approaching direction and disposed at positions separated from each other, the sheet member having a higher bending rigidity than that of any of the positive and negative electrodes and the separator.

### Advantageous Effects of Invention

According to the present invention, there is provided a flat-winding type secondary battery having a simple structure and thus capable of being manufactured in a simplified manufacturing process. The other problems, configurations, and effects other than those described above will be made clear by the following explanation of embodiments.

### BRIEF DESCRIPTION OF DRAWINGS

FIG. 1 is an external perspective view of a flat-winding type secondary battery.

FIG. 2 is an exploded perspective view of the flat-winding type secondary battery.

FIG. 3 is an exploded perspective view of a winding group.

FIG. 4 is a configuration diagram of a winder.

FIG. 5 is a view for explaining a configuration of a winding center portion of the winding group in Example 1.

FIG. 6 is a view for explaining a method of winding a sheet member and a separator in Example 1.

FIG. 7 is a view for explaining a method of winding a sheet member and a separator in Example 1.

FIG. 8 is a view for explaining a configuration of the winding center portion of the winding group in Example 2.

FIG. 9 is a view for explaining a method of winding the sheet member and separator in Example 2.

FIG. 10 is a view illustrating a modification of the winding group in Example 2.

FIG. 11 is a view illustrating a modification of the winding group in Example 2.

FIG. 12 is a view for explaining a configuration of the winding center portion of the winding group in Example 3.

FIG. 13 is a view for explaining a method of winding the sheet member and separator in Example 3.

FIG. 14 is a view for explaining a configuration of the winding center portion of the winding group in Example 4.

FIG. 15 is a view for explaining a method of winding the sheet member and separator in Example 4.

FIG. 16 is a view for explaining a configuration of the winding center portion of the winding group in Example 5.

FIG. 17 is a view illustrating an example of a method of welding the sheet member and separator in Example 5.

FIG. 18 is a view for explaining a method of winding the sheet member and separator in Example 5.

FIG. 19 is a view for explaining a configuration of the winding center portion of the winding group in Example 6.

FIG. 20 is a view illustrating an example of a method of welding the sheet member and separator in Example 6.

FIG. 21 is a view for explaining a method of winding the sheet member and separator in Example 6.

### DESCRIPTION OF EMBODIMENTS

An embodiment of the present invention will be described below using the drawings.

The present invention is a flat-winding type secondary battery having a winding group obtained by winding positive and negative electrodes around a shaft core in a flat form with a separator interposed therebetween. The shaft core is formed by winding a resin sheet having a higher bending rigidity than any of the positive and negative electrodes and separator by less than one turn, and has two bent portions and plane portions at both ends of the bent portions. Further, two end portions of the resin sheet in circumferential direction are opposed to each other with a gap therebetween.

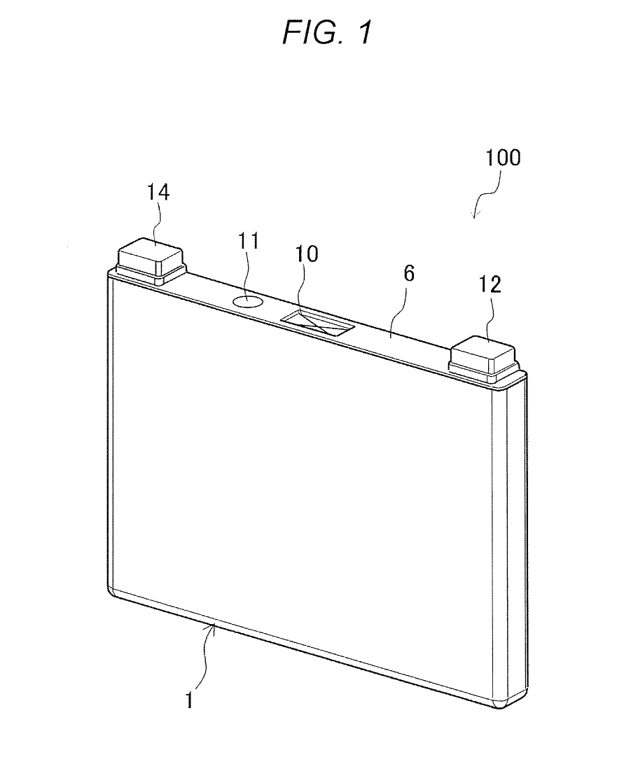

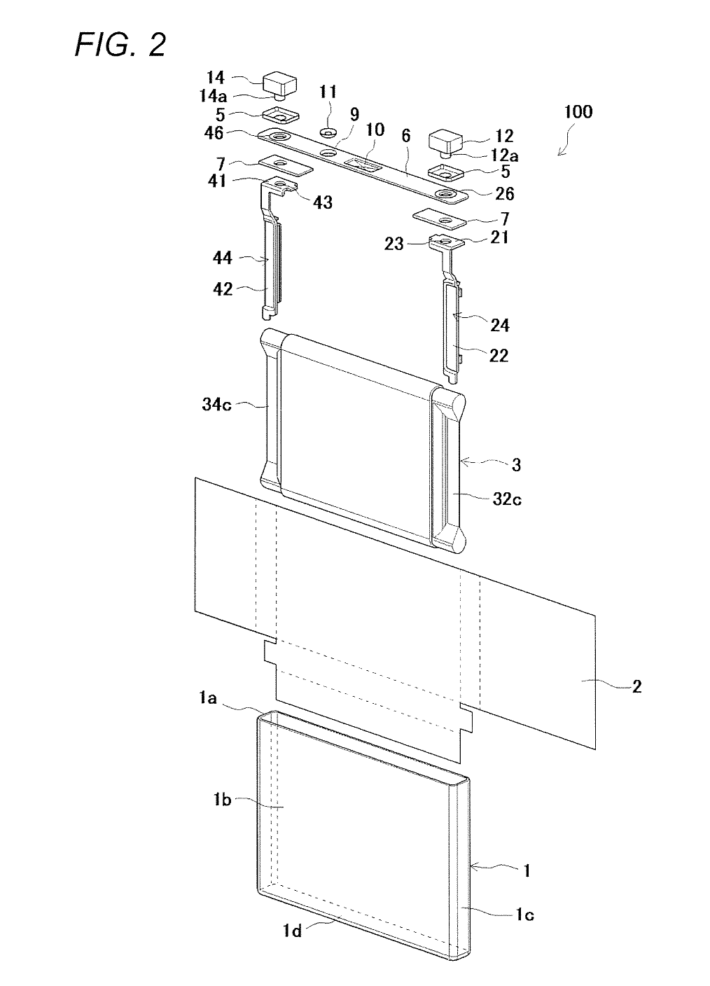

FIG. 1 is an external perspective view of a flat-winding type secondary battery, and FIG. 2 is an exploded perspective view of the rectangular secondary battery.

A flat-winding type secondary battery 100 has a battery can 1 and a lid (battery lid) 6. The battery can 1 has a pair of opposing wide side surfaces 1b each having a relatively large area, a pair of opposing narrow side surfaces 1c each having a relatively small area, and a bottom surface 1d. Further, the battery can 1 has an opening portion 1a at an upper portion thereof.

A winding group 3 is housed in the battery can 1, and the opening portion 1a of the battery can 1 is sealed by the battery lid 6. The battery lid 6 has a substantially rectangular plate shape. The battery lid 6 is welded so as to close the upper opening portion 1a of the battery can 1, thereby sealing the battery can 1.

The battery lid 6 has a positive electrode external terminal 14 and a negative electrode external terminal 12. Through the positive electrode external terminal 14 and negative electrode external terminal 12, power is charged to the winding group 3 or power is supplied to an external load. The battery lid 6 is integrally provided with a gas exhaust valve 10. When a pressure inside a battery vessel is increased, the gas exhaust valve 10 is opened to discharge gas from inside the battery vessel, whereby the pressure inside the battery vessel is reduced. Thus, safety of the flat-winding type secondary battery 100 can be secured. The winding group 3 is housed in the battery can 1 with an insulating protective film 2 interposed therebetween.

The winding group 3 is wound in a flat form and has a pair of opposing curved surface portions each having a semicircular shape in cross section and a flat surface portion continuously formed between the pair of opposing curved surface portions. The winding group 3 is inserted into the battery can 1 from one curved surface portion side such that a winding axis direction extends along a width direction of the battery can 1, and the other curved surface portion side is disposed on the opening portion 1a side.

A positive electrode foil exposing portion 34c of the winding group 3 is electrically connected, through a positive electrode collector plate (collector terminal) 44, to the positive electrode external terminal 14 provided on the battery lid 6. A negative electrode foil exposing portion 32c of the winding group 3 is electrically connected, through a negative electrode collector plate (collector terminal) 24, to the negative electrode external terminal 12 provided on the battery lid 6. Thus, power is supplied from the winding group 3 to an external load through the positive electrode collector plate 44 and negative electrode collector plate 24, and externally generated power is supplied and charged to the winding group 3 through the positive electrode collector plate 44 and negative electrode collector plate 24.

A gasket 5 and an insulating plate 7 are provided on the battery lid 6 so as to electrically insulate the positive and negative electrode collector plate 44 and 24, and the positive and negative electrode external terminals 14 and 12 from the battery lid 6 respectively. After injection of electrolyte into the battery can 1 through an injection port 9, an injection plug 11 is joined to the battery lid 6 by laser welding to seal the injection port 9 to thereby hermetically seal the flat-winding type secondary battery 100.

For example, an aluminum alloy can be used as a material for forming the positive electrode external terminal 14 and positive electrode collector plate 44, and a copper alloy can be used as a material for forming the negative electrode external terminal 12 and negative electrode collector plate 24. Further, for example, a resin material having an insulating property, such as polybutylene terephthalate, polyphenylene sulfide, perfluoro alkoxy fluorine resin can be used as a material for forming the insulating plate 7 and gasket 5.

The injection port 9 for injecting electrolyte in the battery vessel is drilled in the battery lid 6. The injection port 9 is sealed by the injection plug 11 after injection of electrolyte into the battery vessel. For example, as electrolyte to be injected into the battery vessel, nonaqueous electrolyte obtained by dissolving lithium salt such as lithium hexafluorophosphate (LiPF₆) into a carbonate ester based organic solvent such as ethylene carbonate can be used.

Each of the positive electrode external terminal 14 and the negative electrode external terminal 12 has a welded joint to which a bus bar and the like are joined by welding. The welded joint has a rectangular parallelepiped block shape protruding from the battery lid 6 in the upper direction, and has a configuration in which a lower surface is opposed to the surface of the battery lid 6 and an upper surface is parallel to the battery lid 6 at a predetermined height position.

A positive electrode connecting portion 14a and a negative electrode connecting portion 12a protrude from lower surfaces of the positive electrode external terminal 14 and negative electrode external terminal 12, respectively, and have columnar leading ends capable of being inserted into a positive electrode side through hole 46 and a negative electrode side through hole 26 of the battery lid 6, respectively. The positive electrode connecting portion 14a and negative electrode connecting portion 12a penetrate the battery lid 6 and protrude toward an inside of the battery can 1 from a positive electrode collector plate base portion 41 and a negative electrode collector plate base portion 21 of the respective positive electrode collector plate 44 and negative electrode collector plate 24. Leading ends of the positive electrode connecting portion 14a and negative electrode connecting portion 12a are caulked to integrally fix the positive and negative electrode external terminals 14 and 12, and the positive and negative electrode collector plates 44 and 24 to the battery lid 6. The gasket 5 is interposed between the positive and negative electrode external terminals 14 and 12, and battery lid 6, and the insulating plate 7 is interposed between the positive and negative electrode collector plates 44 and 24, and battery lid 6.

The positive and negative electrode collector plates 44 and 24 have the rectangular positive and negative electrode collector plate base portions 41 and 21 disposed opposite to a lower surface of the battery lid 6 and a positive electrode side connecting end portion 42 and a negative electrode side connecting end portion 22 which are folded at side ends of the positive electrode collector plate base portion 41 and negative electrode collector plate base portion 21, extend toward the bottom surface side along a wide surface of the battery can 1, and connected to the positive electrode foil exposing portion 34c and negative electrode foil exposing portion 32c of the winding group 3 in a state being overlapped thereon. In the positive electrode collector plate base portion 41 and negative electrode collector plate base portion 21, a positive electrode side opening hole 43 and a negative electrode side opening hole 23 through which the positive electrode connecting portion 14a and negative electrode connecting portion 12a are inserted, respectively, are formed.

The insulating protective film 2 is wound around the winding group 3 with a direction along the flat surface of the winding group 3 and perpendicular to a winding axis direction of the winding group 3 as a center axis direction. The insulating protective film 2 is formed of a single synthetic resin sheet such as PP (polypropylene) or a plurality of film members and has a length long enough to be wound around the winding group 3 by one turn or more in the direction parallel to the flat surface of the winding group 3 and perpendicular to the winding axis direction of the winding group 3 as the winding center direction.

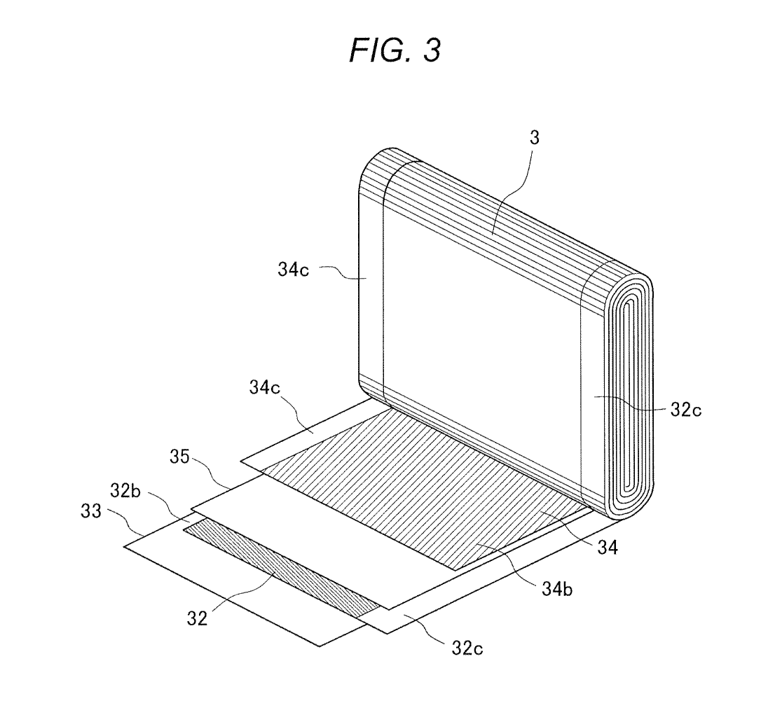

FIG. 3 is an exploded perspective view illustrating a state where a part of the winding electrode group is developed.

The winding group 3 is formed by winding a negative electrode 32 and a positive electrode 34 with separators 33 and 35 interposed therebetween. The negative electrode 32 is wound as the outermost peripheral electrode of the winding group 3, and the separator 33 or 35 is wound outside the outermost negative electrode 32. The separators 33 and 35 each play a role of insulating the positive electrode 34 and negative electrode 32 from each other.

A part of the negative electrode 32 on which a negative electrode mixture layer 32b is coated is larger in the width direction than a part of the positive electrode 34 on which a positive electrode mixture layer 34b is coated. Thus, by overlapping the negative electrode 32 and positive electrode 34 such that both end portions of the negative electrode mixture layer 32b protrude from both end portions of the positive electrode mixture layer 34b in the width direction, the positive electrode mixture layer 34b is sandwiched by the negative electrode mixture layers without fail. The positive electrode foil exposing portion 34c and negative electrode foil exposing portion 32c are bundled at their flat surfaces and connected to each other by welding or the like. Although the separator 33 and 35 are each larger in the width direction than the negative electrode mixture layer 32b, they do not interfere with bundling and welding processes since they are bundled at positions where metal foil surfaces at end portions of the positive electrode foil exposing portion 34c and negative electrode foil exposing portion 32c are exposed.

The positive electrode 34 has a positive electrode active material mixture on both surfaces of a positive electrode foil as a positive electrode collector. The positive electrode foil exposing portion 34c on which the positive electrode active material mixture is not coated is provided at one end portion of the positive electrode foil in the width direction.

The negative electrode 32 has a negative electrode active material mixture on both surfaces of a negative electrode foil as a negative electrode collector. The negative electrode foil exposing portion 32c on which the negative electrode active material mixture is not coated is provided at the other end portion of the negative electrode foil in the width direction. The positive electrode foil exposing portion 34c and negative electrode foil exposing portion 32c are each an area where a metal surface of the electrode foil is exposed and are disposed at one side and at the other side in the winding axis direction, respectively.

A negative electrode mixture for the negative electrode 32 is produced by adding 10 parts by weight of polyvinylidene fluoride (hereinafter, referred to as PVDF) as a binder to 100 parts by weight of an amorphous carbon powder as the negative electrode active material, then adding N-methylpyrrolidone (hereinafter, referred to as NMP) as a dispersant solvent to the above chemical substances, and kneading a thus-obtained solution. The obtained negative electrode mixture is coated onto both surfaces of the copper foil (negative electrode foil) having a thickness of 10 μm, excluding a welding portion (negative electrode uncoated part). This coating operation is followed by drying, press-working, and cutting to obtain the negative electrode 32 having a 70 μm thick part coated with the negative electrode active material, the coated part not including the copper foil.

In the present embodiment, the amorphous carbon is used as the negative electrode active material; however, the kind of negative electrode active material is not limited to this, but may be a natural graphite into/from which lithium ions can be inserted/desorbed, various artificial graphite materials, carbonaceous materials including coke, a chemical compound including Si or Sn (SiO, TiSi₂, etc.), or a composite material thereof. In addition, the negative electrode active material may have a scale-like, globular, fibrous, clumpy, or any other particle shape; the particles of the active material are not limited to these shapes.

A positive electrode mixture for the positive electrode 34 is produced by adding 10 parts by weight of scale-like graphite as an electrically conductive material and 10 parts by weight of PVDF as a binder to 100 parts by weight of lithium manganate (chemical formula: LiMn₂O4) as the positive electrode active material, then adding NMP as a dispersion solvent to the above chemical substances, and kneading a thus-obtained solution. The obtained positive electrode mixture is coated onto both surfaces of the aluminum foil (positive electrode foil) having a thickness of 20 μm, excluding a welding portion (positive electrode uncoated part). This coating operation is followed by drying, press-working, and cutting to obtain the positive electrode 31 having a 90 μm thick part coated with the positive electrode active material, the coated part not including the aluminum foil.

In the present embodiment, the lithium manganate is used as the positive electrode active material; however, the kind of positive electrode active material is not limited to this, but may be any other appropriate lithium manganate having a spinel crystal structure, a lithium-manganese composite oxide partially substituted by or doped with a metal element, lithium cobalt oxide or lithium titanate having a layered crystal structure, or a lithium-metal composite oxide obtained by substituting a part of these oxides by, or doping a part thereof with, a metal element.

In addition, in the present embodiment, the PVDF is used as the binding agent for the coated parts of the positive and negative electrodes; however, the PVDF may be replaced by, for example, polytetrafluoroethylene (PTFE), polyethylene, polystyrene, polybutadiene, butyl rubber, nitrile rubber, styrene-butadiene rubber, polysulfide rubber, nitrocellulose, cyanoethylcellulose, various kinds of latex, acrylonitrile, vinyl fluoride, vinylidene fluoride, propylene fluoride, chloroprene fluoride, a polymer of an acrylic resin, etc., and a mixture of these plastics and resins.

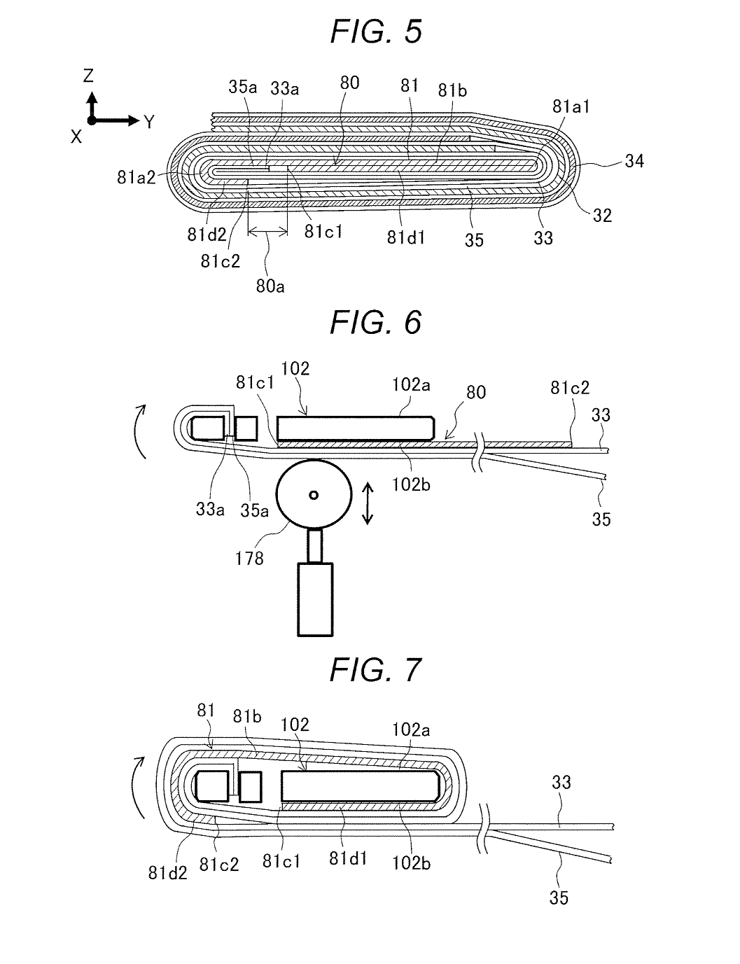

The winding group 3 has a shaft core 80 (see FIG. 5) at its center.

The shaft core 80 is formed by folding a resin sheet member 81 having a higher bending rigidity than that of any of a positive electrode foil 31a, a negative electrode foil 32a, and separator 33. Details of a configuration of the shaft core 80 will be described later.

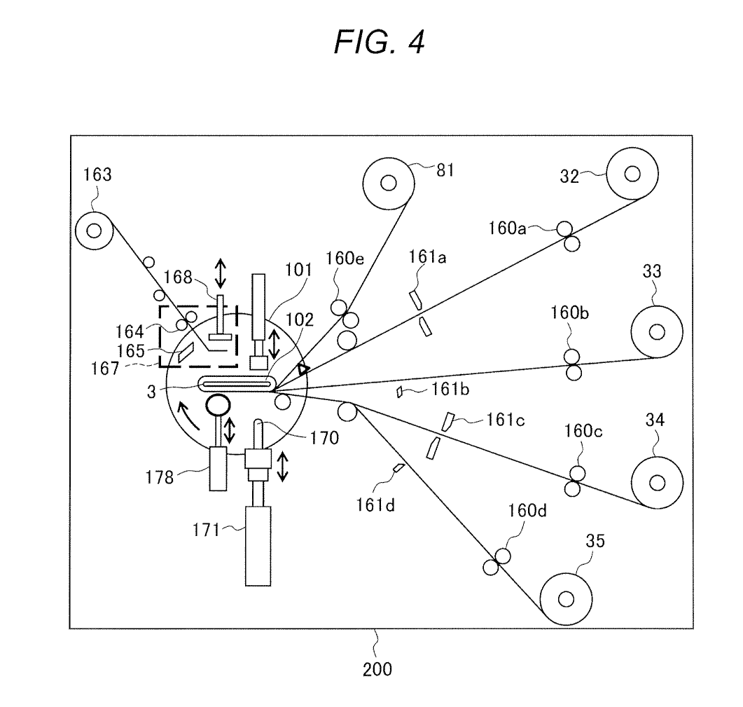

FIG. 4 is a view illustrating a configuration example of a winder.

A winder 200 has a spindle 101 rotatably supported at its center and is driven into rotation in a clockwise direction by a not illustrated rotary driving device. There is provided, at a side of the spindle 101, a supply device for supplying a sheet member 81, a negative electrode 32, a separator 33 (first separator), a positive electrode 34, a separator 35 (second separator) to the spindle 101.

The supply device retains the sheet member 81, the negative electrode 32, the separator 33, the positive electrode 34, and the separator 35, which are each wound in a roll shape, in the mentioned order from upper right of the device. The above members are each delivered from an outer peripheral end portion and supplied to the spindle 101. Further, there are provided feed rollers 160a to 160e for supplying the electrodes 32 and 34, the separators 33 and 35, and the sheet member 81 to predetermined positions, respectively, and cutters 161a to 161d for cutting the electrodes 32 and 34, the separators 33 and 35 and the sheet member 81, into a predetermined length, respectively. The illustration of the cutter for cutting the sheet member 81 is omitted.

The spindle 101 is attached with a flat winding core 102 and provided with a temporarily pressing mechanism 178 for holding the sheet member 81 wound around the winding core 102 so as to prevent the sheet member 81 from being unwound when it is cut.

There is provided, near the winding core 102, a sticking means 167 for sticking an adhesive tape 163 so as to prevent the winding group 3 formed by rotating the winding core 102 from being unwound. The sticking means 167 is a part surrounded by a dashed line in the drawing and has a feed mechanism 164, a cutter 165, and a sticking mechanism 168. The adhesive tape 163 is delivered by the feed mechanism 164 by a predetermined length, cut by the cutter 165 into a predetermined length, and stuck to the winding group 3 by the sticking mechanism 168.

Further, there are provided as needed, near the spindle 101, a heater head 170 for heating/welding the separators 33 and 35 to the sheet member 81 and a heater movement mechanism 171 for moving the heater head 170 to a predetermined position for pressurization. As another example, it is possible to join the separators 33 and 35 to the sheet member 81 by means of an adhesive tape other than heating/welding. In this case, although not illustrated, the same mechanism as the sticking means 167 for sticking a tape is additionally provided in place of the heater head 107 and heater movement mechanism 171.

In the winder 200, the sheet member 81 and at least one of the separators 33 and 35 are retained to the winding core 102. Then, by a rotation of the winding core 102, the sheet member 81 and separators 33 and 35 are wound. The sheet member 81 is directly brought into contact with the winding core 102, and the separator 33 is brought into contact with the sheet member 81.

An example of a manufacturing method for the electrode group by the winder 200 will be described below.

First, the sheet member 81 and at least one of the separators 33 and 35 are directly retained to the winding core 102. Then, the winding core 102 is rotated to wind the sheet member 81 and separators 33 and 35. The sheet member 81 is wound around the winding core 102 by the separators 33 and 35 and folded in a flat form along a shape of the winding core 102, and the separators 33 and 35 are wound around the sheet member 81.

Then, the negative electrode 32 is inserted and sandwiched between a winding body obtained by winding the separators 33 and 35 around the sheet member 81 by one turn or more and the separator 33 wound outside the winding body. Then, at a timing later than the insertion of the negative electrode 32, the positive electrode 34 is inserted and sandwiched between the separator 33 and separator 35 outside the separator 33. The winding core 102 is rotated by a predetermined number of times.

Then, the outside of the outermost positive electrode 34 is covered by the outermost negative electrode 32 by making a winding terminal end of the outermost negative electrode 32 longer than a winding terminal end of the positive electrode 34 by one turn or more. The outside of the outermost negative electrode 32 is covered by the separators 33 and 35. End portions of the separators 33 and 35 are fixed by the sticking means 167 sticking the adhesive tape 163 so as to prevent the winding group 3 from being unwound. Thereafter, the winding group 3 is removed from the winding core 102 and then pressed in a thickness direction thereof to be formed into a final shape (see FIG. 3).

A method of winding the sheet member 81 and separators 33 and 35 around the winding core 102 includes, for example: making the winding core 102 retain only the separators 33 and 35 and sandwiching the sheet member 81 between the winding core 102 and separators 33 and 35, followed by winding them together; making the winding core 102 retain only the sheet member 81 and heating/welding the separators 33 and 35 to the sheet member 81 by means of the heater head 170, followed by winding them together; making the winding core 102 retain both the sheet member 81 and the separators 33 and 35 and winding them together; and making the winding core 102 and sheet member 81 retain the separators 33 and 35 and winding them together.

### Example 1

The following describes Example 1 of the present embodiment.

FIG. 5 is a view for explaining a configuration of a winding center portion of the winding group in Example 1, and FIGS. 6 and 7 are views for explaining a method of winding the separator around the winding core in Example 1.

The winding group 3 is wound in a flat form by the winder 200, then removed from the winding core 102, and pressed in the flat thickness direction thereof to be formed into a final shape. In this state, the winding group 3 has a substantially track shape in cross section in which a semicircular arc-shaped curved surface is formed at both end portions of the flat surface in the winding direction (see FIG. 3).

The sheet member 81 constituting the shaft core 80 is disposed in a center portion of the winding group 3. In a state before the winding group 3 is pressed, end portions of the sheet member 81 in the winding direction are folded in a mutually approaching direction (see FIG. 7). In a state where the winding group 3 is formed into a pressed final shape, it is pressed and crushed into a flat-plate shape, as illustrated in FIG. 5. The sheet member 81 is wound around the winding core 102 by less than one turn, as illustrated in FIG. 7.

The shaft core 80 has a configuration in which leading end portions 81c1 and 81c2 in the winding direction of the sheet member 81 are folded in a mutually approaching direction to be disposed at positions separated from each other by a predetermined gap 80a.

Specifically, as illustrated in FIG. 5, the shaft core 80 has a planar base plate portion 81b extending in the winding direction, a pair of bent portions 81a1 and 81a2 folded in a mutually approaching direction at one and the other sides of the base plate portion 81b, respectively, in the winding direction, and a pair of folded piece portions 81d1 and 81d2 extending along the base plate portion 81b from the pair of bent portions 81a1 and 81a2 in a mutually approaching direction.

The following describes a method of forming the winding group using FIGS. 6 and 7.

First, as illustrated in FIG. 6, winding start ends of the respective separators 33 and 35 are retained at one surface 102a side of the winding core 102. Then, the winding core 102 is rotated while being pressed by the temporarily pressing mechanism 178 to wind the separators 33 and 35 over one end portion of the winding core 102 in the winding direction while sandwiching a winding start end of the sheet member 81 between the other surface 102b of the winding core 102 and separator 33.

Then, the winding core 102 is further rotated to wind the separators 33 and 35 around the winding core 102 by one turn or more, as illustrated in FIG. 7. Thus, the sheet member 81 is folded along the winding core 102 to be wound therearound by less than one turn. In this state, the base plate portion 81b is disposed at the one surface 102a side of the winding core 102, and the leading end portions 81c1 and 81c2 are disposed at the other surface 102b side of the winding core 102.

Then, the winding core 102 is rotated after release of the pressing by the temporarily pressing mechanism 178. Then, first a winding start end of the negative electrode 32 is inserted between the separator 35 and separator 33 outside the separator 35 at the one surface 102a side of the winding core 102. Subsequently, at a slightly later timing, a winding start end of the positive electrode 34 is inserted between the separator 33 and separator 35 outside the separator 33. Then, the winding core 102 is rotated by a predetermined number of times to thereby form the winding group 3 including the positive and negative electrodes 34 and 32 each having a predetermined length.

Then, after the outermost separator 35 is fixed to the outer peripheral surface of the winding group 3 by the adhesive tape, retention of the separators 33 and 35 by the winding core 102 is released, and the winding group 3 is removed from the winding core 102. Then, the resultant winding group 3 is pressed in the thickness direction with a predetermined pressing force, to be formed into a final shape (see FIG. 5).

The above-described winding group 3 can be produced only by retaining the resin sheet 81 and separators 33 and 35 to the winding core 102 and winding them therearound. Thus, a simple structure can be achieved to simplify a manufacturing process. For example, it is possible to omit work of previously inserting a cylindrical shaft core into the spindle of the winder 200, which is necessary in the conventional approach, thereby improving productivity by automation. Further, it is possible to eliminate the need to previously produce the cylindrical shaft core, thereby reducing cost by the cost of the cylindrical shaft core. That is, the winding group 3 is suitable for mass-production.

In the present example, only the winding start ends 33a and 35a of the separators 33 and 35 are retained to the winding core 102 of the winder 200, and the sheet member 81 is inserted/sandwiched between the separators 33 and 35 and winding core 102 for retention and wound around the winding core 102. This makes it possible to omit work of retaining the leading end portion 81c1 of the sheet member 81 to the winding core 102 of the winder 200. Thus, a simple structure can be achieved to simplify a manufacturing process.

As illustrated in FIG. 5, the winding group 3 has, at its center portion, the flat-plate shaped shaft core 80 crushed in the flat thickness direction (Z-direction in FIG. 5) by pressing. The shaft core 80 has the pair of bent portions 81a1 and 81a2 which are separated from each other in the winding direction (Y-direction in FIG. 5) and each extend in a winding axis direction (X-direction in FIG. 5). Thus, it is possible to regulate a length of the shaft core 80 in the winding direction (Y-direction) to be constant at all times, thereby reducing variation among products.

Further, existence of the pair of bent portions 81a1 and 81a2 prevents the separators 33 and 35 and negative and positive electrodes 32 and 34 from being bent in an angular manner, whereby the separators 33 and 35 and negative and positive electrodes 32 and 34 can be smoothly bent so as to have a semicircular arc shape in cross section.

Particularly, according to the present example, in the shaft core 80, one folded piece portion 81d1 having the leading end portion 81c1 and base plate portion 81b are directly opposed to each other, and the winding start ends 33a and 35a of the two separators 33 and 35 are sandwiched, in a two-folded state, between the other folded piece portion 81d2 having the leading end portion 81c2 and base plate portion 81b.

Thus, a radius of the innermost peripheral surface of a bent part of the negative electrode 32 wound outside the bent portion 81a2 of the shaft core 80 and a radius of the innermost peripheral surface of a bent part of the negative electrode 32 wound outside the bent portion 81a1 of the shaft core 80 both become a value obtained by adding thicknesses of four separators and a thickness of the sheet member 81 and are equal to each other. This prevents the minimum radius of the bent part of the negative electrode 32 on one of the both sides from becoming minimized to thereby reduce a peeling direction force to be applied to the negative electrode mixture of the bent part. This allows an increase in pressing pressure against the negative electrode mixture layer 32b of the negative electrode 32 for increase in density of the negative electrode mixture layer 32b, thereby improving battery performance.

In the present example, the separators 33 and 35 are interposed between the shaft core 80 and the negative electrode 32 without fail. This makes it possible to sufficiently supply electrolyte even to the innermost negative electrode 32 through the separators 33 and 35, thereby improving battery reactivity.

The above-mentioned gap 80a of the shaft core 80 is formed over the center portion of the winding group 3 in the winding axis direction. Thus, it is possible to supply electrolyte to the center portion of the winding group 3 through the gap 80a, thereby uniformly supplying the electrolyte over the entire winding group 3. This improves reactivity inside the battery to achieve high battery performance.

Further, in the present embodiment, the negative electrode 32 is wound after the separators 33 and 35 are wound around the shaft core 80 by one turn or more. That is, the separators 33 and 35 are wound over the entire outer periphery of the shaft core 80 in a directly contacting manner. Thus, the gap 80a between the leading end portions 81c1 and 81c2 of the shaft core 80 can be closed by the separators 33 and 35 to thereby planarizing irregularities on the surface of the shaft core 80. Thus, when the negative and positive electrodes 32 and 34 are wound around the shaft core 80, it is possible to prevent irregularities caused due to the gap 80a from being formed on the negative electrode 32.

Further, the shaft core 80 is formed by folding the resin sheet member 81 having a higher bending rigidity than that of any of the positive electrode foil 31a, negative electrode foil 32a, and separator 33, so that it is possible to generate, at the center position of the winding group 3, a biasing stress in a direction that enlarges a distance between the base plate portion 81b and folded piece portions 81d1 and 81d2 by spring back of the pair of bent portions 81a1 and 81a2. This prevents loosening of the winding group 3 to thereby ensure vibration resistance and impact resistance.

### Example 2

Example 2 in the present embodiment will be described.

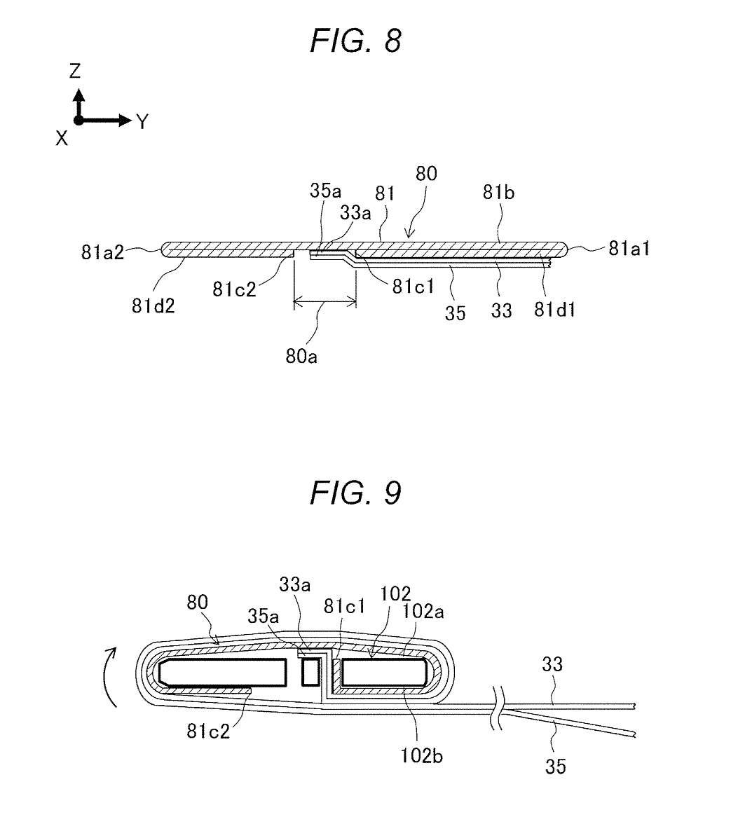

FIG. 8 is a view for explaining a configuration of the winding center portion of the winding group in Example 2, and FIG. 9 is a view for explaining a method of winding the sheet member and separator in Example 2. The same reference numerals are given to the same or similar components to those of Example 1, and the detailed description thereof will be omitted.

The present example has a configuration in which the winding start ends of the separators 33 and 35 are disposed in the gap 80a. The shaft core 80 has a configuration in which one folded piece portion 81d1 and base plate portion 81b are directly opposed to each other, and the other folded piece portion 81d2 and base plate portion 81b are directly opposed to each other. The winding start ends of the separators 33 and 35 are disposed in the gap 80a, and the separators 33 and 35 are wound around the shaft core 80.

The above-described winder 200 is used to produce the winding group 3 having the shaft core 80 in the present example. In this case, first, as illustrated in FIG. 9, the winding start end 81c1 of the sheet member 81 and winding start ends 33a and 35a of the separators 33 and 35 are overlapped on each other and inserted into a slit from the other surface 102b side of the winding core 102 to be retained to the winding core 102. At this time, the winding start ends 33a and 35a of the separators 33 and 35 is made to protrude, at the one surface 102a side of the winding core 102, longer than the winding start end 81c1 of the sheet member 81 by a length within the gap 80a. As in Example 1, the sheet member 81 has a length which wounds around the winding core 102 by less than one turn.

Then, the winding core 102 is rotated to wind the separators 33 and 35 therearound by one turn or more. As a result, the sheet member 81 is folded along the winding core 102 and wound by less than one turn. In this state, the base plate portion 81b is disposed at the one surface 102a side of the winding core 102, and the leading end portions 81c1 and 81c2 are disposed at the other surface 102b side of the winding core 102.

Then, as in Example 1, the winding core 102 is further rotated to insert and sandwich the negative electrode 32 between a winding body obtained by winding the separators 33 and 35 around the sheet member 81 by one turn or more and separator 33 wound outside the winding body. Then, at a timing later than the insertion of the negative electrode 32, the positive electrode 34 is inserted and sandwiched between the separator 33 and separator 35 outside the separator 33, and the winding core 102 is rotated by a predetermined number of times to thereby form the winding group 3. The winding group 3 is removed from the winding core 102 and then pressed in a thickness direction thereof with a predetermined pressing force, to be formed into a final shape.

According to the present example, the winding group 3 can be produced only by retaining the resin sheet 81 and separators 33 and 35 to the winding core 102 and winding them therearound. Thus, a simple structure can be achieved to simplify a manufacturing process.

The winding group 3 is retained to and wound around the winding core 102 in a state where the winding start ends 33a and 35a of the separators 33 and 35 protrude longer than the one winding start end 81c1 of the sheet member 81. Thus, the winding start ends 33a and 35a of the separators 33 and 35 wound at the outer peripheral side protrude longer than the winding start end 81c1 of the sheet member 81 wound at the inner peripheral side toward the gap 80a side and housed in the gap 80a. This allows the gap 80a to be partially filled with the winding start ends 33a and 35a of the separators 33 and 35, whereby a height of a step formed by the gap 80a can be lowered. Accordingly, it is possible to prevent irregularities caused due to the gap 80a from being formed on the negative and positive electrodes 32 and 34, thereby allowing the negative and positive electrodes 32 and 34 to be completely and tightly fitted to each other through the separators 33 and 35.

The winding group 3 is wound with the separators 33 and 35, and are brought into contact with at least a part of the outer periphery of the shaft core 80 constituted by the sheet member 81. Thus, the separators 33 and 35 are disposed also at the inner peripheral side of the innermost negative electrode 32, allowing electrolyte to be retained by the separators 33 and 35. This makes it possible to uniformly supply the electrolyte over the entire winding group 3, improving battery reactivity.

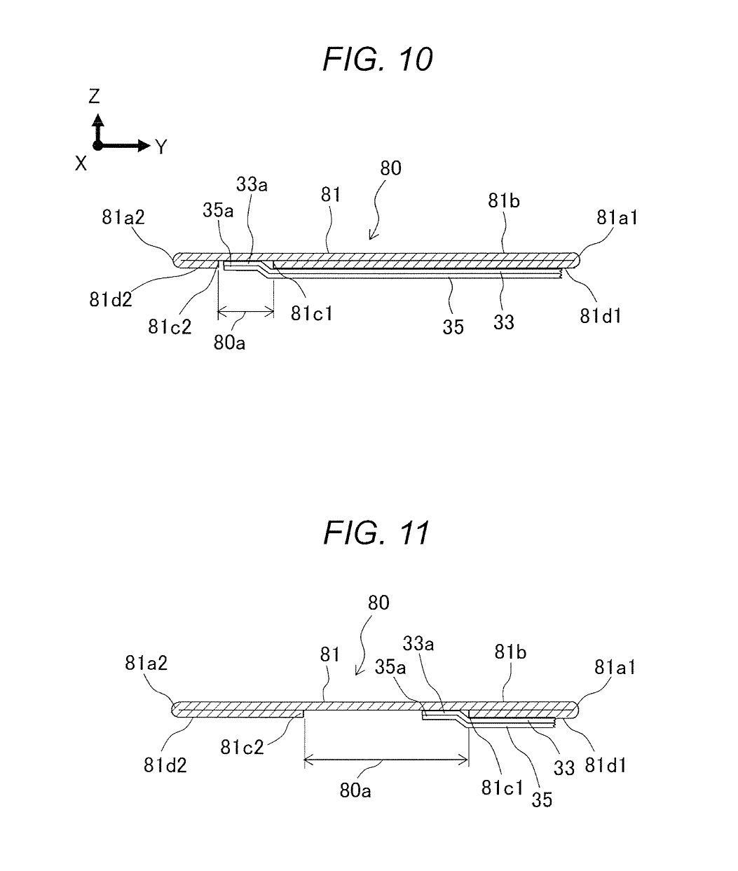

FIGS. 10 and 11 are views each illustrating a modification of the winding group of the present example.

A modification illustrated in FIG. 10 is featured in that a position of the gap 80a is shifted to an upstream side (left side in the drawing) upon winding time as compared to the configuration example illustrated in FIG. 8. The winding group 3 is rotated in a clockwise direction to be wound in a state illustrated in FIG. 10. The one folded piece portion 81d1 positioned at the upstream side upon winding is longer than the other folded piece portion 81d2 positioned at the downstream side upon winding, and the leading end portion 81c2 is disposed at a position close to the other bent portion 81a2. Thus, it is possible to make a wide contact area between the separator 33 and folded piece portion 81d1 when the separators 33 and 35 are started to be wound.

Thus, when the separators 33 and 35 are wound on the bent portion 81a1 of the shaft core 80 at the start of winding the separator 33 and 35, it is possible to prevent the separators 33 and 35 each having a lower rigidity than that of the sheet member 81 from being excessively pulled by back tension of the winder 200. The position of the gap 80a may be shifted to the downstream side (right side in the drawing) upon winding. In this case, lengths of the separators 33 and 35 to be pulled are made shorter to reduce the lengths of the affected separators. Also in the present configuration example, the winding group 3 can be produced only by retaining the sheet member 81 and separators 33 and 35 to the winding core 102 and winding therearound. Thus, a simple structure can be achieved to simplify a manufacturing process.

A modification illustrated in FIG. 11 is featured in that a size of the gap 80a is increased as compared to the configuration example illustrated in FIG. 8. In the present example, the entire length of the resin sheet 181 can be shortened, and material cost can be saved by the reduction in the entire length, resulting in cost reduction. As in the case where the gap 80a is shifted to the downstream side (right side in the drawing) upon winding, it is possible to make the lengths of the separators 33 and 35 to be pulled shorter to reduce the lengths of the affected separators 33 and 35.

### Example 3

Example 3 in the present embodiment will be described.

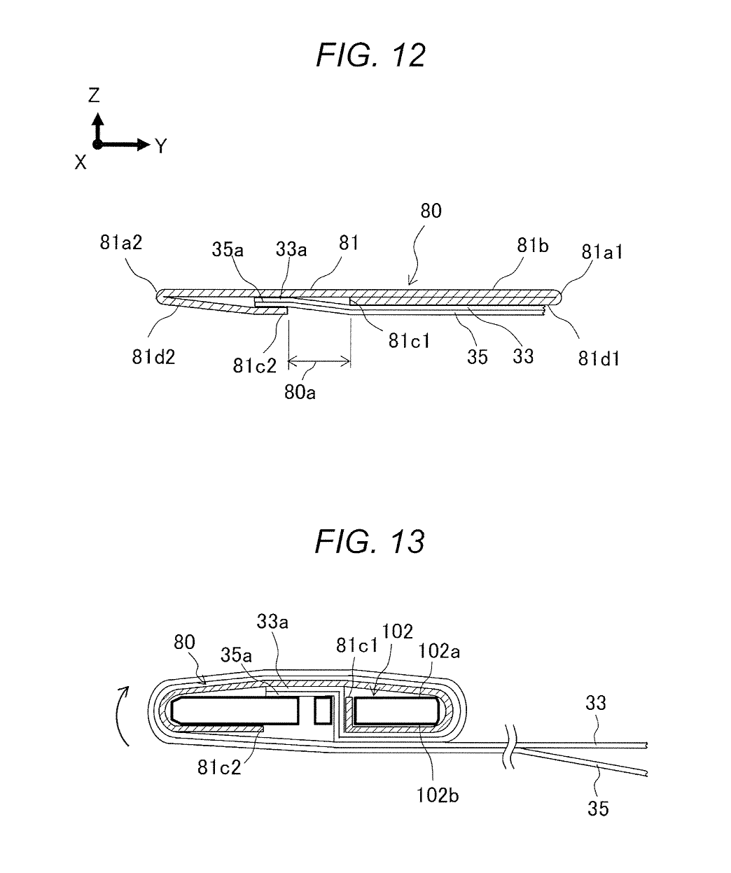

FIG. 12 is a view for explaining a configuration of the winding center portion of the winding group in Example 3, and FIG. 13 is a view for explaining a method of winding the sheet member and separator in Example 3. The same reference numerals are given to the same or similar components to those of Examples described above, and the detailed description thereof will be omitted.

The winding group 3 in the present example has a configuration in which the winding start ends of the separators 33 and 35 are made to pass through the gap 80a of the shaft core 80 and then sandwiched between the base plate portion 81b and folded piece portion 81d2.

As illustrated in FIG. 13, when the winding group 3 in the present example is produced, the winding start ends 33a and 35a of the separators 33 and 35 and leading end portion 81c1 of the sheet member 81 are inserted into the slit from the other surface 102b side of the winding core 102 and retained therein. At this time, leading ends of the separators 33 and 35 are made to protrude at the one surface 102a side of the winding core 102 by a predetermined length. Then, the winding core 102 is rotated to wind the separators 33 and 35 therearound by one turn or more.

As a result, the sheet member 81 is folded along the winding core 102 and wound by less than one turn. In this state, the base plate portion 81b is disposed at the one surface 102a side of the winding core 102, and the leading end portions 81c1 and 81c2 are disposed at the other surface 102b side of the winding core 102. Then, the winding core 102 is rotated to wind therearound the negative and positive electrodes 32 and 34 to form the winding group 3. After that, the winding group 3 is removed from the winder 200 and then pressed in a thickness direction thereof to be formed into a final shape.

The shaft core 80 is crushed in a thickness direction by pressing to be formed into a flat-plate shape, in which the one folded piece portion 81d1 and base plate portion 81b are opposed to each other, and the other folded piece portion 81d2 and base plate portion 81b are opposed to each other. The separators 33 and 35 are protruded from the leading end portion 81c1 of the sheet member 81 to pass through the gap 80a, and the winding start ends 33a and 35a are sandwiched between the other folded piece portion 81d2 of the shaft core 80 and base plate portion 81b.

The present example differs from the above Example 1 in that the winding start ends 33a and 35a of the separators 33 and 35 are not folded in two between the folded piece portion 81d2 and base plate portion 81b. The separators 33 and 35 pass through the gap 80a and are then overlapped on the one folded piece portion 81d1.

According to the present example, the winding start ends 33a and 35a of the separators 33 and 35 are sandwiched between the folded piece portion 81d2 and base plate portion 81b, thus preventing the winding start ends 33a and 35a being free ends and thus from being moved. In the present example, the leading end portion 81c1 of the sheet member 81 and separators 33 and 35 are collectively retained to the winding core 102 of the winder, so that retaining work is required only once, whereby a simple structure can be achieved to simplify a manufacturing process.

Another configuration may be adopted, in which the sheet member 81 is sandwiched and fixed between the separators 33 and 35 to be wound around the winding core 102 and winding core 102 and then wound. Further, as described above, also in the present example, the position and size of the gap 80a are not limited to those in the example illustrated in FIG. 12 but may be changed as illustrated in FIGS. 10 and 11.

### Example 4

Example 4 in the present embodiment will be described.

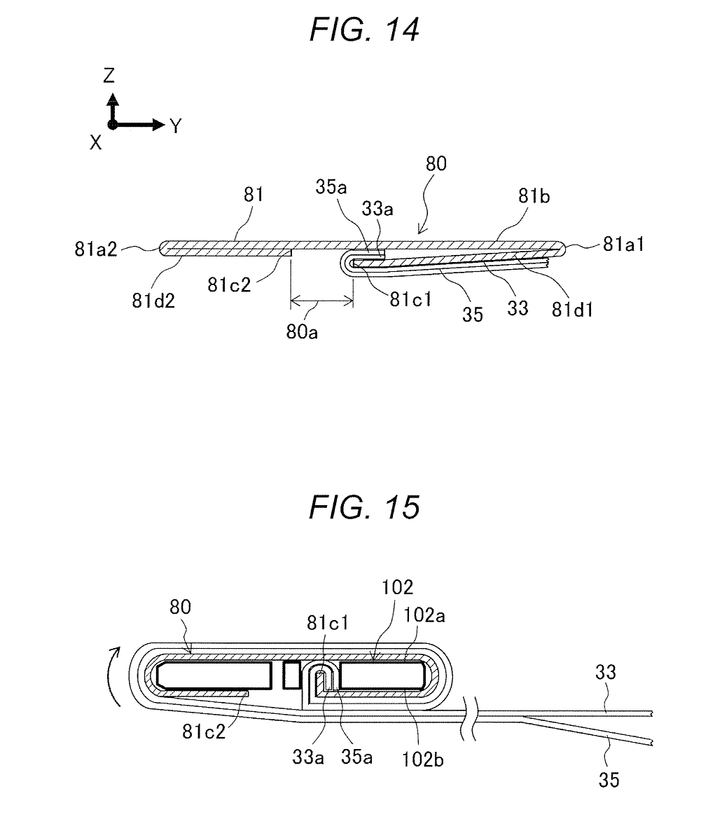

FIG. 14 is a view for explaining a configuration of the winding center portion of the winding group in Example 4, and FIG. 15 is a view for explaining a method of winding the sheet member and separator in Example 4. The same reference numerals are given to the same or similar components to those of Examples described above, and the detailed description thereof will be omitted.

The winding group 3 in the present example has a configuration in which the winding start ends of the separators 33 and 35 are made to pass through the gap 80a of the shaft core 80 and then sandwiched between the base plate portion 81b and one folded piece portion 81d1.

As illustrated in FIG. 15, when the winding group 3 in the present example is produced, the winding start ends 33a and 35a of the separators 33 and 35 are folded, and the folded winding start ends 33a and 35a are inserted into the slit of the winding core 102 and retained therein with the leading end portion 81c1 of the sheet member 81 sandwiched therebetween. Then, the winding core 102 is rotated to wind the separators 33 and 35 therearound by one turn or more. As a result, the sheet member 81 is folded along the winding core 102 and wound by less than one turn. In this state, the base plate portion 81b is disposed at the one surface 102a side of the winding core 102, and the leading end portions 81c1 and 81c2 are disposed at the other surface 102b side of the winding core 102.

Then, the winding core 102 is rotated to wind therearound the negative and positive electrodes 32 and 34 to form the winding group 3. After that, the winding group 3 is removed from the winder 200 and then pressed in a thickness direction thereof to be formed into a final shape.

The shaft core 80 is crushed in a thickness direction by pressing to be formed into a flat-plate shape, in which the one folded piece portion 81d1 and base plate portion 81b are opposed to each other, and the other folded piece portion 81d2 and base plate portion 81b are opposed to each other. The separators 33 and 35 are made to pass through the gap 80a and folded so as to sandwich the leading end portion 81c1 of the sheet member 81 therebetween, and the winding start ends 33a and 35a are sandwiched between the one folded piece portion 81d1 and base plate portion 81b of the shaft core 80.

According to the present example, the winding start ends 33a and 35a of the separators 33 and 35 are sandwiched between the folded piece portion 81d1 and base plate portion 81b, thus preventing the winding start ends 33a and 35a being free ends and thus from being moved.

In the present example, the leading end portion 81c1 of the sheet member 81 and separators 33 and 35 are collectively retained to the winding core 102 of the winder, so that retaining work is required only once, whereby a simple structure can be achieved to simplify a manufacturing process. Further, as described above, also in the present example, the position and size of the gap 80a are not limited to those in the example illustrated in FIG. 14 but may be changed as illustrated in FIGS. 10 and 11.

### Example 5

Example 5 in the present embodiment will be described.

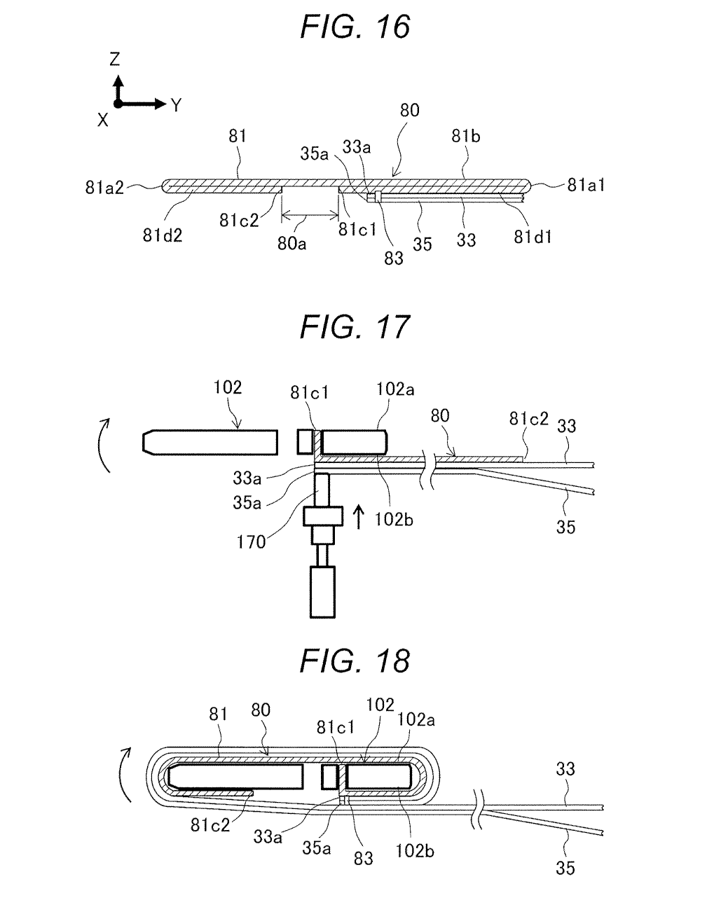

FIG. 16 is a view for explaining a configuration of the winding center portion of the winding group in Example 5, and FIGS. 17 and 18 are views for explaining a method of winding the sheet member and separator in Example 5. The same reference numerals are given to the same or similar components to those of Examples described above, and the detailed description thereof will be omitted.

The winding group 3 in the present example has a configuration in which the winding start ends of the separators 33 and 35 are welded to the shaft core 80. As illustrated in FIG. 17, when the winding group 3 in the present example is produced, the leading end portion 81c1 of the sheet member 81 is inserted into the slit from the other surface 102b side of the winding core 102 and retained therein.

Then, the winding start ends 33a and 35a of the separators 33 and 35 are heat-welded for fixation to the sheet member 81. The heat-welding is made by overlapping the winding start ends 33a and 35a of the separators 33 and 35 on the one folded piece portion 81d1 of the sheet member 81 and pressing the heated heater head 170 against the winding start ends 33a and 35a. As a result, a welded portion 83 is formed between the sheet member 81 and winding start ends 33a and 35a of the separators 33 and 35.

Then, the winding core 102 is rotated to wind the separators 33 and 35 therearound by one turn or more. As a result, the sheet member 81 is folded along the winding core 102 and wound by less than one turn. In this state, the base plate portion 81b is disposed at the one surface 102a side of the winding core 102, and the leading end portions 81c1 and 81c2 are disposed at the other surface 102b side of the winding core 102. Then, the winding core 102 is rotated to wind therearound the negative and positive electrodes 32 and 34 to form the winding group 3. After that, the winding group 3 is removed from the winder 200 and then pressed in a thickness direction thereof to be formed into a final shape.

According to the present example, a process of retaining the winding start ends 33a and 35a of the separators 33 and 35 to the winding core 102 of the winder 200 can be omitted, whereby a simple structure can be achieved to simplify a manufacturing process.

According to the present example, the winding start ends 33a and 35a of the separators 33 and 35 are fixed by heat-welding to the sheet member 81, so that it is possible to enhance adhesion between the separators 33 and 35 and sheet member 81, thereby preventing a failure such as come-off of the separators 33 and 35. It is possible to enhance adhesion between the separators 33 and 35 and sheet member 81, thereby preventing a failure such as come-off of the separators 33 and 35. Further, it is possible to prevent the winding start ends 33a and 35a of the separators 33 and 35 being free ends and thus from being moved.

In the present example, it is not necessary to retain the winding start ends 33a and 35a of the separators 33 and 35 to the winding core 102, so that it is not necessary for the winding start ends 33a and 35a of the separators 33 and 35 to protrude longer than the leading end portion 81c1 of the sheet member 81 wound at the inner peripheral side toward the gap 80a side. Further, as described above, also in the present example, the position and size of the gap 80a are not limited to those in the example illustrated in FIG. 16 but may be changed as illustrated in FIGS. 10 and 11.

### Example 6

Example 6 in the present embodiment will be described.

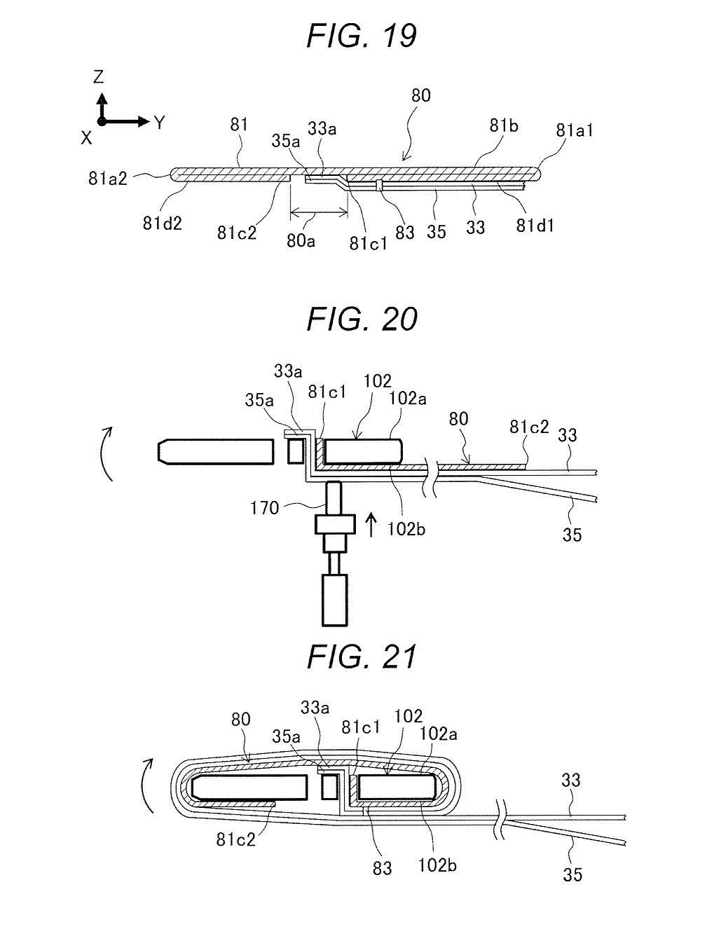

FIG. 19 is a view for explaining a configuration of the winding center portion of the winding group in Example 6, and FIGS. 20 and 21 are views for explaining a method of winding the sheet member and separator in Example 6. The same reference numerals are given to the same or similar components to those of Examples described above, and the detailed description thereof will be omitted.

The winding group 3 in the present example has a configuration in which the separators 33 and 35 are welded to the shaft core 80, and the winding start ends 33a and 35a are disposed in the gap 80a. First, as illustrated in FIG. 20, when the winding group 3 having the shaft core 80 in the present example is produced using the above-described winder 200, the winding start ends 81c1 of the sheet member 81 and the winding start ends 33a and 35a of the separators 33 and 35 are overlapped on each other and retained to the winding core 102. At this time, the winding start ends 33a and 35a of the separators 33 and 35 is made to protrude, at the one surface 102a side of the winding core 102, longer than the winding start end 81c1 of the sheet member 81 by a length within the gap 80a. As in Example 1, the sheet member 81 has a length which wounds around the winding core 102 by less than one turn.

Then, the sheet member 81 and separators 33 and 35 overlapped on each other at the other surface 102b side of the winding core 102 are fixed to each other by heat-welding. The heat-welding is made by pressing the heater head 170 against the separators 33 and 35 from thereoutside in a thickness direction thereof. As a result, a welded portion 83 is formed between the sheet member 81 and winding start ends 33a and 35a of the separators 33 and 35.

Then, as illustrated in FIG. 21, the winding core 102 is rotated to wind the separators 33 and 35 therearound by one turn or more. As a result, the sheet member 81 is folded along the winding core 102 and wound by less than one turn. In this state, the base plate portion 81b is disposed at the one surface 102a side of the winding core 102, and the leading end portions 81c1 and 81c2 are disposed at the other surface 102b side of the winding core 102. Then, the winding core 102 is rotated to wind therearound the negative and positive electrodes 32 and 34 to form the winding group 3. After that, the winding group 3 is removed from the winder 200 and then pressed in a thickness direction thereof to be formed into the above-described final shape.

According to the present example, the winding start ends 33a and 35a of the separators 33 and 35 are fixed by heat-welding to the sheet member 81, so that it is possible to enhance adhesion between the separators 33 and 35 and sheet member 81, thereby preventing a failure such as come-off of the separators 33 and 35. Further, as described above, also in the present example, the position and size of the gap 80a are not limited to those in the example illustrated in FIG. 19 but may be changed as illustrated in FIGS. 10 and 11.

Further, a position of the welded portion 83 may be set to near the bent portion 81a1 at the right side in the drawing, not at the leading end portion 81c1 side of the sheet member 81. In this case, as described above, lengths of the separators to be pulled are made shorter to reduce the lengths of the affected separators.

The embodiments of the present invention have been described in detail. The present invention is not limited to the above embodiments and thus various design changes may be made within the spirit of the invention as described in the appended claims. For example, the embodiments described above are detailed explanation for facilitating the understanding of the invention, and the invention is not limited to those having all the configurations described above. The configuration of one of the embodiments may be partially replaced with the configuration of another embodiment or the configuration of one of the embodiments may be added to the configuration of another embodiment. The addition, deletion, and replacement of configurations are possible partially in the configurations of the embodiments.

### REFERENCE SIGNS LIST

1 battery can
3 winding group
6 battery lid
32 Negative electrode
33, 35 separator
33a, 35a winding start end
34 positive electrode
80 shaft core
80a gap
81 sheet member
81a1, 81a2 bent portion
81b base plate portion
81c1, 81c2 leading end portion
81d1, 81d2 folded piece portion
83 welded portion
100 flat-winding type secondary battery

1. A flat-winding type secondary battery, comprising:
a flat-shaped winding group obtained by winding positive and negative electrodes with a separator interposed therebetween,
the winding group having a shaft core having a configuration in which leading end portions of a sheet member at both sides in a winding direction are folded in an a mutually approaching direction and disposed at positions separated from each other with a gap interposed therebetween and in which the separator is disposed in the gap between the separated leading end portions of the shaft core, the sheet member having a higher bending rigidity than that of any of the positive and negative electrodes and the separator.

2. The flat-winding type secondary battery according to claim 1, wherein
the shaft core includes:
a planar base plate portion extending in the winding direction;
a pair of bent portions folded in a mutually approaching direction at one and the other sides of the base plate portion, respectively, in the winding direction; and
a pair of folded piece portions extending along the base plate portion from the pair of bent portions in a mutually approaching direction and having the leading end portions, respectively.

3. The flat-winding type secondary battery according to claim 2, wherein
the separator is interposed between the shaft core and the negative electrode.

4. The flat-winding type secondary battery according to claim 3, wherein
the separator is wound in a state brought into contact with the entire outer periphery of the shaft core.

5. The flat-winding type secondary battery according to claim 3, wherein
a winding start end of the separator is disposed in a gap between the separated leading end portions of the shaft core.

6. The flat-winding type secondary battery according to claim 3, wherein
a winding start end of the separator is sandwiched between one of the pair of folded piece portions and the base plate portion.

7. The flat-winding type secondary battery according to claim 3, wherein
with a winding start end of the separator folded in two and sandwiched between one of the pair of folded piece portions and the base plate portion, the separator passes through a gap between the opposing leading end portions of the shaft core and wound in a state overlapped on the other one of the pair of folded piece portion.

8. The flat-winding type secondary battery according to claim 3, wherein
a winding start end of the separator is sandwiched between one of the pair of folded piece portions and the base plate portion and folded to interpose the leading end portions of the one of the pair of folded piece portions between its folded portions.

9. The flat-winding type secondary battery according to claim 1, wherein
the separator is welded to the shaft core.
